(19) United States
(12) Patent Application Publication
(10) Pub. No.: US 2004/0232571 A1
(43) Pub. Date: Nov. 25, 2004

(54) Method for manufacturing low PMD single-mode fiber and optical fiber manufactured by the same

(76) Inventors: Weijun Tong, Wuhan (CN); Zhenbao He, Wuhan (CN); Shuqiang Zhang, Wuhan (CN); Jie Luo, Wuhan (CN)

Correspondence Address: Min (Amy) S. Xu, Esq., DORSEY & WHITNEY LLP, Intellectual Property Department, 50 South Sixth Street, Suite 1500, Minneapolis, MN, 55402-1498, US

(21) Appl. No.: 10/802,660

(22) Filed: Mar. 17, 2004

(30) Foreign Application Priority Data
Mar. 28, 2003 (CN) 03118858.3

(51) Int. Cl. B29D 11/00

(52) U.S. Cl. 264/1.24

(57) ABSTRACT

The invention relates to a method for manufacturing low PMD single-mode fiber and a fiber manufactured by said method. The twisting system is mounted at the downstream side of a normal fiber-drawing tower. The manner of twisting does not change the fiber-drawing path, the axis of twisting wheels periodically swing in a plane which is parallel to the fiber-drawing direction. The fiber moving at high speed makes the outer surfaces of the twisting wheels to rotate round the axis of the fiber, when an angle between the plane in which the twisting wheels are located and the fiber-drawing direction exists, the component of the angular velocity in the radial direction of the fiber reacts on the fiber and makes the fiber to twist, and the twist propagates to the soften region of the glass material at the fiber-drawing upstream in the form of mechanical wave, a plastic deformation is produced and set up in the newly drawn fiber. The non-sinusoidal twist distribution of confused frequencies and amplitudes is introduced in the length direction of the fiber, and the energy coupling between the two orthogonal polarization modes is increased, the birefringence of said modes initiates PMD of the fiber. The PMD coefficient of the fiber manufactured by the method is less than 0.03 ps/km^{1/2}.

### CROSS-REFERENCE TO RELATED APPLICATION(S)

This application claims priority to Chinese Patent Application No. 03118858.3, filed on Mar. 28, 2003, the contents of which is incorporated in its entirety by reference.

### TECHNICAL FIELD

The invention relates to a method for manufacturing single-mode fiber, more particularly to a method for manufacturing low polarization mode dispersion (PMD) single-mode fiber. The invention also relates to an optical fiber manufactured by said method.

### BACKGROUND ARTS

In recent years, along with the rapidly increasing requirement of communication bandwidth, the transmission rate of a single channel over the backbone network is rising from Gb/s level to Th/s level in many countries. This development is owed to the application of erbium-doped fiber-amplifier (EDFA) and other optical devices. However, a serious problem is thus generated, that is, the original slight polarization effects, such as PMD, polarization dependent loss (PDL), and other adverse effects, are accumulated, and finally the effect produced by them is non-negligible. Because the PDL is a loss introduced mainly by optical isolator, optical divider and optical filter, practically it shall not be the main factor of limiting the high bit rate transmission, if polarization- independent performance is ensured for each of these devices. On the other hand, the PMD is accumulated when the signal propagates along the optical path. At present there is not any effective way to avoid or solve it. Therefore, it is considered in many references that PMD has become the ultimate limitation of high bit rate transmission. In addition, though the investigations concerning compensation of PMD have been carried out for many years, and some solutions have been developed, however, no matter the way of adopting fixed or variable PMD equalizer, or the way of compensating respectively the signals in mutually orthogonal directions after decomposition, there are some discontented technical respects. Therefore, for the manufactures of optical fiber, the urgent matters are to investigate the source of PMD and to optimize and stabilize the PMD performance of fibers in technology.

Typically only LP₀₁ or HE₁₁ mode propagates over backbone network. Practically a fundamental mode is also constituted by two mutually orthogonal linear polarization modes. An ideal single-mode fiber should have an ideal circular symmetrical structure, so that the two mutually orthogonal linear polarization modes in the fiber have the same propagation performance, i.e., they are degenerate modes. However, because imperfection always exists in the practical single-mode fiber, and the circular symmetry is destroyed. This leads to a difference that exists between the refractive indices of the two orthogonal polarization components, and a birefringence performance appears. If an input optical pulse activates two orthogonal polarization components, and they propagate along the fiber with different group velocities, then the pulse is widened. This phenomenon is referred to as polarization mode dispersion (PMD).

It has been proved by a great lot of experiments that for a short fiber, the differential group delay (DGD) generated by polarization mode dispersion is proportional to the length of the fiber; and for a long fiber, the DGD is proportional to the square root of the length of the fiber. Therefore, the PMD coefficient for a long fiber is defined as follows:

PMD=ΔT/z^{1/2}. (1)

When the length of a fiber is much longer than the polarization mode coupling length, the DGD value of a fiber is a random parameter, which should satisfy the Maxwell probability distribution function, and its mean value is:

<ΔT(z)=(8/π)^{1/2}δT(zL_{c})^{1/2}, (2)

where δT is the intrinsic DGD of unit length, L_{c} is the polarization mode coupling length, and z is the practical length of a fiber, which is much longer than L_{c}.

Generally, it is held that there are two types of factors that generate birefringence and PMD in single-mode fiber: one is intrinsic, which includes elliptical core, twist, pure bending, transverse pressure distribution, axial tension distribution, and so on; the other is extrinsic, which includes temperature, and other environmental factors. Therefore, in order to obtain lower PMD, most manufacturers make use of effective technologies to control the ellipticity of the core and unsymmetrical distribution of the stress, so as to lower δT and L_{c} of the fiber. Because these measures are limited technically, therefore how to effectively increase the mode coupling of polarization modes so as to lower δT and L_{c} are considered in many current investigations. The main object of investigation is increasing twist purposely in the fiber-drawing process.

One way of decreasing PMD in the prior art is to spin a fiber preform in the fiber-drawing process. See, for example, Barlow et al., Applied Optics, 20: 2962, 1981; Payne et al., IEEE Journal of Quantum Electronics, QE-18: 477-487, 1982; Rashleigh, “Fabrication of Circularly Birefringent Single-Mode Fibers”, Navy Technical disclosure Bulletin, 5: 7-12, 1980; and WO 83/00232, and so on. The decrease of PMD obtained by spinning fiber preform is proportional to the spin velocity. Unfortunately, a relatively high spin velocity is always required for handling the asymmetry of typical optical fiber. Therefore, this measure can only be used in low-speed fiber-drawing process of small diameter preform. As regards the current big preform fiber-drawing process which fiber-drawing speed exceeds 800 m/min, the effect of lowing PMD by spinning fiber preform is hardly effectible.

The other way of decreasing PMD in the prior art is to introduce a means for horizontally twisting optical fiber at the lower part of a fiber-drawing machine (take-up end) so as to generate a mechanical wave spinning in the horizontal direction. Such a mechanical wave is delivered to the softened region of a preform in a fiber-drawing furnace using the fiber as a medium. The produced plastic deformation is maintained into the fiber being drawn. Such a way for reducing PMD by rotation is comparatively applicable to the current high-speed fiber-drawing process of preform having large diameter, and many manufacturers of optical fibers adopt it. There are a number of relevant patent applications, for example, US005298047A, US00541881a, US2002/0134114A, US006324872B1, US005897680A, US006148131A, and Chinese Patent 97190345.X, 97191779.5, and so on. It has been understood through in-depth investigations that a more notable effect of energy coupling between two orthogonal modes producing birefringence can be obtained by non-sinusoidal periodical twisting fiber with frequency modulation and/or amplitude modulation.

A typical way of applying the external driving force directly to the optical fiber and making it being twisted has been disclosed in the patents US005897680A, US006148131A. Such a way is referred to as “horizontal twist with paired-roll”. An electric motor spinning with a given frequency makes one end of a connecting rod to perform circular movement, and the other end of the connecting rod performs back and forth movement in the horizontal plane, and it is hinged to another connecting rod on which a pair of twisting wheels is fixed. By way of selecting a suitable fulcrum on the other connecting rod, said pair of twisting wheels can always perform relatively back and forth movement in the direction perpendicular to the fiber-drawing direction. At the same time the surfaces of the twisting wheels contact directly with optical fiber, the twisting wheels can rotate round their axes respectively. It can be seen from the way of operation introduced therefrom that the effect of twisting optical fiber is obviously superior to that of spinning preform. The direction of twisting fiber changes periodically between clockwise direction and counter clockwise direction. However, it can be found from theoretical calculations and practical tests that the turns per meter of the twisted fiber depends on the fiber-drawing speed and the rotation frequency of the electric motor, so it is unsuitable for notably decreasing PMD parameter in the current high-speed fiber-drawing process. In addition, it can be derived from the analyze of the structure of the twisting system that the locus of the periodical back and forth movement of the twisting wheels in the horizontal plane is the waveform of sine or cosine function, and the theoretical twist waveform of optical fiber approximates to the sine or cosine function waveform. The patents US 2002/0134114A1, US006324872B1 also have the aforesaid feature. The difference of the ways of twisting fiber between the patent US2002/0134114A1 and patents US005897680A and US006148131A is: the fiber-drawing path is changed by the surface of twisting wheels. Therefore, the contact area between the optical fiber and the surface of twisting wheels is increased, and a better effect of twisting fiber is attained. The differences of the ways of twisting fiber between the patent US006324872B1 and patents US005897680A and US006148131A are: the twisting wheels are replaced by a pair of rolls, and the periodical movement of the pair of rolls can be controlled to obtain different twist period.

The patents US005298047A, US006324872B1 and Chinese patent 97190345.X, 97191779.5 and so on introduced another typical way of twisting fiber, and such a way is referred to as “continuous swing of single wheel”. The basic concept of realization of said way comprises: making the surface of the twisting wheel to contact with fiber; making the fiber to deviate from its original fiber-drawing path within a small range; the plane in which the twisting wheel is located swings periodically so that a variable angle is formed between the vertical plane and the fiber-drawing direction; the drawing force suffered by the fiber is applied to the outer surface of twisting wheel, then the twisting wheel spins round its axis; the spin perpendicular to the direction of fiber-drawing reacts on the fiber, then the fiber spins in the plane perpendicular to the fiber-drawing direction, and finally the twist of fiber is formed. According to the concrete way of realization, the characteristic of the technical line of the patents US005298047A, US005418881A is: the fiber suffered a torque swings back and forth because it suffers a transverse pulling force on the surface of twisting wheel. On the other hand, the characteristic of the technical line of the patent US006324872B1, and the Chinese patents 97190345.X, 97191779.5 is disposing two slotted wheels for positioning above and below the twisting wheel respectively to limit the transverse swing of the fiber.

The characteristic of the way of twisting described in the aforesaid patents is distinguishable essentially from that of horizontal twist with paired-roll, for the effect of horizontal twist depends on the rotation frequency of electric motor and the fiber-drawing speed. Theoretically, the way of continuous swing of single wheel is suitable for the high-speed fiber-drawing process, and it is capable of forming a non-sinusoidal twist waveform. However, the way of continuous swing of single wheel described above changes the fiber-drawing path of the original fiber-drawing process, and makes the fiber to deviate from the collimation of the fiber-drawing system. First, such a way is disadvantageous for the process control of normal fiber-drawing process, and the difficulty of maintaining equipment increases. In addition, the resistance of forced spin of the optical fiber is increased, and the capability of forming torque by the twisting system described in the aforesaid patents is weakened. Moreover, the precondition of obtaining good effect of twisting described in the above-described patents is the close contact between the fiber and the surface of twisting wheel. However, the force applied between them originates from the horizontal component of the fiber-drawing force, and its magnitude depends on the angle of the fiber deviating from the fiber-drawing direction on the surface of twisting wheel and the fiber-drawing force. In addition, considering that the slippage of the optical fiber on the surface of twisting wheel, so the fiber bounces inevitably on the surface of twisting wheel, and the transfer of the torque of the twisting wheel to the fiber cannot be ensured.

### SUMMARY OF THE INVENTION

The object of the invention is to develop a method for manufacturing low PMD single-mode fiber so as to overcome the aforesaid defects that exist in the prior art. Said method is suitable for the current high-speed fiber-drawing process of large diameter preform. A good effect of twisting can be obtained by said method, and the PMD performance of a single-mode fiber is greatly optimized.

In order to settle the aforesaid technical problem, the technical solution of the invention is: fixing a preform to a preform feeding mechanism at the top of a fiber-drawing tower; then sending it into a fiber-drawing heating furnace and performing the fiber-drawing process therein; making the drawn fiber to pass through bare fiber geometrical dimension monitor, coating system, twisting system, fiber-drawing tension wheel, finished optical fiber geometrical dimension monitor and take-up system successively. The fiber is always kept in its vertical direction between the fiber-drawing heating furnace and the fiber-drawing tension wheel, and the path of the fiber is unchanged by the contact surface between the other systems and the optical fiber, i.e., a good collimation is maintained for the fiber. The motion of the fiber includes a linear motion that originates from the action of the fiber-drawing force and a spin that originates from the torque introduced by the twisting system and takes the fiber-drawing direction as its axis. The fiber is forced to spin with the fiber-drawing direction as its axis under the action of the torque introduced by the twisting system. The spin direction of the optical fiber is changed periodically along with the back and forth swing of the twisting wheel in a plane that is parallel to the fiber, and a special mechanical wave is formed. Such a mechanical wave can propagates along the fiber towards the upstream fiber-drawing direction. Such a mechanical wave can attain the softened region of a preform in the fiber-drawing furnace, it causes a plastic deformation of the glass material in the softened region, and said deformation is set up in the newly drawn optical fiber, As shown in FIG. 1, wherein:

a pair of twisting wheels of said twisting system apply their action on the fiber, the swing direction and the axial slope angle to the fiber of the plane in which the two twisting wheels are located are always in axial symmetrical state, and the two twisting wheels always apply a given compressive stress on the fiber; and

the driving force introduced by said twisting system indirectly exerts to the fiber, and the driving force for twisting fiber originates from the friction between the fiber moving in the fiber-drawing direction and the twisting wheels.

In the aforesaid method for manufacturing optical fiber, the compressive stress applied by the two twisting wheels has a typical value of 0.5˜5N, so as to ensure the existence of friction between the twisting wheels and the fiber.

In the aforesaid method for manufacturing fiber, the twist of the fiber is realized by the following way: when there is a slope angle between the plane in which the twisting wheels are located and the fiber-drawing direction, the moving optical fiber brings along the twisting wheels to rotate round the axis of the fiber through friction, the fiber radial component of the angular velocity for the rotation of the twisting wheels applies reaction on the fiber through friction, so that the twist of the fiber is produced.

In the aforesaid method for manufacturing fiber, the typical mean value of the twist of said fiber is 25˜100 turns/m, the typical value of the coefficient of PMD of the fiber is not greater than 0.03ps/km^{1/2}.

In the aforesaid method for manufacturing fiber, the distribution waveform of the twist of said fiber in the length direction may be realized in different forms to combine periodical by constant amplitude components and constant frequency components with variable amplitude components and variable frequency components, the typical twist waveforms are the following three forms:

a. the twist waveform does not include constant amplitude components and constant frequency components and non-twisted component in a period;

b. the twist waveform includes constant amplitude components and constant frequency components and non-twisted component in a period; and

c. the twist wave form includes constant amplitude components and constant frequency components, but does not include non-twisted component in a period.

In the aforesaid method for manufacturing fiber, said twisting system has a pair of positioning wheels. The plane in which said positioning wheels are located and the plane in which the moving twisting wheels are located are always perpendicular each other, the outer surface of the positioning wheels do not apply compressive stress on the fiber.

In the aforesaid method for manufacturing fiber, a hard metal alloy having high polish precision may be selected as the material of the twisting wheels or the positioning wheels of said twisting system that contact with the fiber directly. The typical value of the surface roughness of said hard metal alloy is not greater than 3 microns. Ceramic material, hard rubber material or plastic material can also be selected.

In the aforesaid method for manufacturing fiber, the motion formed by the twisting wheel has three forms: a pair of twisting wheels are stable in their vertical positions simultaneously; a pair of axes of twisting wheels are stable in their maximum slope angle positions symmetrically; and a pair of axes of twisting wheels swing symmetrically between their vertical positions and maximum slope angle positions.

In the aforesaid method for manufacturing fiber, the twist of optical fiber produced by the twisting system can be controlled through the control of swing angle of the twisting wheels and the proportion of time distribution among three motion forms.

In the aforesaid method for manufacturing fiber, the typical value of the maximum swing angle of the plane in which the twisting wheels located is 5˜20 degrees.

In the aforesaid method for manufacturing fiber, said preform may be a solid or a preform produced by rod-in-tube process; the typical value of the outer diameter of the preform is φ40˜150 mm; the typical value of the fiber-drawing speed of said fiber-drawing tower is 400˜1500 m/min; said fiber-drawing heating furnace comprises mainly graphite resistance furnace and graphite induction furnace that are suitable for fiber-drawing process for large diameter preform; the typical value of the fiber-drawing temperature is 1730˜2300° C.

In accordance with the other aspect of the invention, the present application further provides a fiber manufactured by using the aforesaid method for manufacturing fiber. The twist of the optical fiber is 25˜100 turns/m. The distribution waveforms of the twist of the fiber in the length direction are different forms to combine constant amplitude components and constant frequency components with variable amplitude components and variable frequency components. The coefficient of PMD is not greater than 0.03 ps/km^{1/2}.

The advantageous effects of the invention are:

1. by using the technical solution of the invention, the twist of the single-mode fiber can be increased significantly, and more twist waveforms of the fiber are provided for selection to decrease the PMD of single-mode fiber so that the PMD coefficient is not greater than 0.03 ps/km^{1/2};

2. by using the twisting system of the invention, the driving force producing the twist of optical fiber originates from the friction between the fiber moving in the fiber-drawing direction and the twisting wheel; said driving force is distinguishing from the external driving force acting on the optical fiber directly supplied by the disclosed twisting system, therefore, the twist of the fiber of the invention is not affected by the fiber-drawing speed, so it is especially suitable for high-speed fiber-drawing process; and

3., since the path of the high-speed fiber-drawing is unchanged during installing and using the aforesaid twisting system, as distinguished from the way used in a part of the disclosed twisting systems that changes the path of the fiber-drawing, potential high frequency dither of the fiber can be avoided while the twist of fiber is introduced, and the stabilization of the fiber-drawing process is not affected while the PMD of the single-mode fiber is lowered.

### BRIEF DESCRIPTION OF THE DRAWINGS

FIG. 1 is a schematic diagram showing the method of the invention, in which: 1—fiber-drawing heating furnace, 2—fiber diameter detecting system, 3—cooling system, 4—coating system, 5—twisting system, 6—fiber diameter detecting system, 7—fiber taking-up system;

FIG. 2 is a schematic diagram analyzing the radial force applied on a fiber;

FIG. 3 is a schematic diagram showing the swing angle of twisting wheels;

FIG. 4a is a diagram showing the typical twist waveform obtained when a pair of rolls are twisting horizontally;

FIG. 4b is a diagram showing the typical twist waveform obtained when a single wheel is swinging continuously;

FIG. 4c is a diagram showing the typical twist waveform that can be realized by the invention.

### DETAILED DESCRIPTION

The twisting system of the invention comprises mainly: servo motor, cam, connecting rod, a pair of twisting wheels, a pair of positioning wheels, springs, and base. The basic operation principle of the manner of twisting will be described in below. The servo motor drives the cam to rotate periodically, then the connecting rod is driven to move back and forth, and the twisting wheels is driven by the connecting rod to swing back and forth in a plane parallel to the fiber. The fiber moving at high speed contacts the outer surface of the twisting wheels and positioning wheels, so that the twisting wheels and the positioning wheels are forced to rotate round their axes. When there is a given slope angle between the plane in which the twisting wheels is located and the fiber-drawing direction, the angular velocities of the rotating twisting wheels have two corresponding components in the fiber-drawing direction and in the radial direction of the fiber. The component of the angular velocity in the fiber-drawing direction matches the fiber-drawing speed; whereas the component of the angular velocity in the radial direction reacts on the fiber, so that the fiber is forced to spin round its axis. The spin direction of the fiber is changed periodically in accordance with the back and forth swing of the twisting wheels in a plane parallel to the fiber, and a special mechanical wave is formed. Such a mechanical wave can propagate along the fiber towards the upstream fiber-drawing direction and the take-up direction. The mechanical wave propagating towards the upstream direction can arrive at the softened region of the preform in the fiber-drawing furnace. Because the viscosity of the glass in the softened region is relatively low, a plastic deformation can be produced therein and is set up in the newly drawn fiber.

The typical mean value of the turns per meter of the twisted fiber is 25˜100 turns/m. The good effect of twisting is ensured by the manner described in below. The twisting system comprises a pair of positioning wheels and a pair of twisting wheels. The plane in which said positioning wheels are located and the plane in which the twisting wheels are located are always perpendicular each other. The swing direction and the axial slope angle to the fiber of the plane in which the two twisting wheels are located are always in axial symmetrical state. The outer surface of the positioning wheels do not apply notable compressive stress on the fiber, and the two twisting wheels always apply a given compressive stress on the fiber, its typical value is 0.5˜5N. Under the precondition of ensuring the structure of the coating layer being not destroyed by twisting, the value of the compressive stress must ensure a good friction between the fiber and the twisting wheels, as shown in FIG. 2. A clear distinction can be drawn between the patents U.S. Pat. No. 6,324,827, U.S. Pat. No. 5,298,047, U.S. Pat. No. 5,418,881 and the invention, for the manner of twisting of the invention restricts the radial motion of the fiber, so that the radial swing and the possible high frequency dither of the fiber coming from the introduction of twisting system can be significantly eliminated, and a stable operation of said twisting process during high speed fiber-drawing can be ensured. Moreover, a clear distinction can be drawn between the manner of independent continuous swing of single wheel disclosed in the patents U.S. Pat. No. 6,324,872, U.S. Pat. No. 5,298,047, U.S. Pat. No. 5,418,881 and the manner described in the invention, for in accordance with the manner of twisting of the invention, a pair of twisting wheels swing axial symmetrically and a mechanical pressure is introduced between the twisting wheels and the fiber, so that the effect of friction and velocity match between the surface of twisting wheels and the fiber is effectively ensured, and the torque applied on the fiber by the twisting wheels for spinning the fiber round its axis and the effect of twisting the fiber can be ensured.

The surface of twisting wheels or positioning wheels of the invention contacts directly the fiber. Selecting the material for forming said surface is an important factor that influences the effect of twist of the fiber. In the twisting system according to the invention, as distinct from the contact manner of the twisting system and the optical fiber disclosed in the patents U.S. Pat. No. 6,324,872, U.S. Pat. No. 5,298,047 and U.S. Pat. No. 5,418,881, the surface of twisting wheels and positioning wheels directly contacts the fiber, and prominent stress and friction exist between them. Thus the material of said surface should possess good wearability. In order to prevent the surface of the optical fiber produced through high speed fiber-drawing process from being scarred, the existence of defects such as burr and unevenness on the surface of twisting wheels or positioning wheels is unallowable. Selecting hard metal alloy having high polishing precision is preferable, and the typical value of surface roughness is not greater than 3 microns. Ceramic material, harder rubber material or plastic material also may be selected, thus the good mechanical efficiency of the twisting system is ensured, and at the same time the coating material on the surface of fiber is prevented from being damaged by the twisting system.

The servo motor of the twisting system of the invention drives the connecting rod, and the motion of the twisting wheels has the following three forms: a pair of twisting wheels are stable in their vertical positions simultaneously; a pair of axes of twisting wheels are stable in their maximum slope angle positions symmetrically; and a pair of axes of twisting wheels swing symmetrically between their vertical positions and maximum angle positions. The proportion of time distribution among three motion forms can be adjusted arbitrarily through controlling the input voltage of the servo motor. Generally speaking, in order to prevent the fiber from high frequency dither that originated from the propagation of the mechanical wave produced by the twisting system so that the performance of the fiber is unaffected, the twisting wheels are stable in their vertical positions for a short time; in order to increase the turns of the horizontally twisted fiber, the twisting wheels are stable in their maximum slope angle positions for a short time; and in order to form non-sinusoidal twist waveform having irregular frequency and amplitude of the fiber, so as to increase the energy coupling between the two orthogonal components producing birefringence and PMD in single-mode fiber, the twisting wheels are swinging back and forth between their vertical positions and maximum slope angle positions.

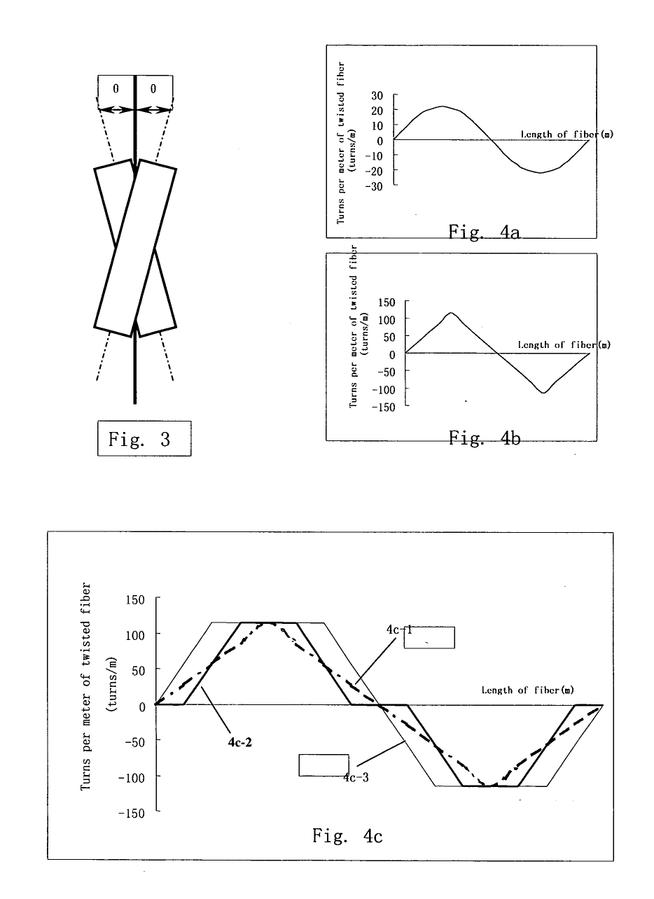

The twisting system of the invention causes the fiber to twist, and the effect of action (which refers mainly to the turns per meter of the fiber and the twist waveform in the length direction of the fiber) can be controlled by controlling the swing angle θ of the twisting wheel (see FIG. 3) and the proportion of time distribution among three motion forms, so that the reduction of PMD of different single-mode fibers can be realized. The typical value of the maximum angle of the plane in which the twisting wheel is located ranges from 5° to 20°. The single-mode fiber for communication having a typical PMD value less than 0.03 ps/km^{1/2} can be manufactured stably after optimization of process parameters.

As shown in FIG. 3, the twisting system of the invention causes the fiber to twist, the characteristics of its effect of action can be proved by theoretical calculation, and the concrete contents will be described in below.

The motion formed by the twisting wheel has three forms: a pair of twisting wheels are stable in their vertical positions simultaneously; a pair of axes of twisting wheels are stable in their maximum slope angle positions symmetrically; and a pair of axes of twisting wheels swing symmetrically between their vertical positions and maximum angle positions. The working state of the main twisting wheel can be described with the following four physical parameters: the time period of staying in the vertical position t₁, the time period of staying in the maximum slope angle position t₂, the swing frequency f₀ or the angular velocity ω₀ of the twisting wheel, and the maximum swing angle θₘₐₓ of the twisting wheel.

According to the technical solution of the invention, when there is a slope angle between the plane in which the twisting wheels of radius R are located and the fiber-drawing direction, the angular frequency o of rotation of the twisting wheel of the twisting system can be decomposed into ω₁=ωsinθ in the radial direction of the fiber and ω₂=ωcosθ in the fiber-drawing direction. The relations between the components of the angular velocity and the motion state of the fiber are the follows:

in the fiber-drawing direction: f₁·V=R·ωcosθ (1)

in the radial direction of the fiber: f₂ R·ωsinθ=υ_{f}·πd (2)

where υ_{f}, d and V are the frequency of the fiber spinning round the axis, the diameter of the fiber, and the fiber-drawing speed, respectively. f₁ is the mechanical efficiency of driving the twisting wheel to rotate by the fiber in the fiber-drawing direction, f₂ is the mechanical efficiency of driving the twisting wheel to rotate by the fiber in the radial direction of the fiber.

The frequency (in turns/sec) of the fiber spinning round the axis can be obtained from the above two equations:

υ_{f}=(f₁·f₂·tgθ)/(πd) (3)

When the fiber-drawing speed is taken into account, the frequency of the fiber spinning round the axis is (in turns per meter):

$$\begin{matrix}{rot}_{θ} = {υ}_{f} / V \\ = ( {f}_{1} \cdot {f}_{2} \cdot tg θ ) / ( π d ) \\ = ( {f}_{0} \cdot tg θ ) / ( π d )\end{matrix} \qquad ( 4 )$$

where f₀ is the mechanical efficiency of the twisting system, which equals the product of f₁ and f₂.

It can be seen from equation (4) that the theoretical calculation proves that the turns per meter of the fiber spinning round the axis produced in the twisting system constructed according to the aforesaid scheme is independent of the fiber-drawing speed. This method is especially suitable for high-speed fiber-drawing process because there is not a restriction on fiber-drawing speed. It is also proved by the theoretical calculation that the turns per meter of the fiber spinning round the axis produced in the twisting system constructed according to the aforesaid scheme is independent of the geometrical dimensions of the twisting wheel and the swing frequency. In light of this, when constructing the twisting system according to the above scheme, none of the special and rigorous criterions in selection servo motor and other component parts is required.

The twisting system of the invention causes the fiber to twist, the characteristics of its effect of action distinguishing from the prior art can also be proved by theoretical calculation, and the concrete contents will be described in below.

The turns of the fiber spinning round the axis and the distribution waveform in the length direction of the twisted fiber are compared based on the theoretical calculation for two disclosed manners of twisting and the manner of twisting of the invention. There is no need to consider the influence of the spin direction of the fiber on the turns of spin, for a plastic deformation of the glass material is produced in the softened region.

1.1 The Manner of Horizontal Twist with Paired-Roll

It is mentioned in Patents US005897680, US006148131 and US006324872 that the manner of twisting of spinning a fiber round its axis can be realized by applying an external force to a pair of circular rolls so that they move in opposite directions back and forth in the plane perpendicular to the axis of the fiber. Since the path length of the pair of rolls in a twisting period relative to the axis of the fiber approximately equals to the length of the arc that the fiber spins, the mean value of the turns per meter of the fiber spinning round its axis is

rot₁=2vₘL/(V·π·d) (5)

where vₘ is the frequency of the back and forth motion of the pair of rolls, L is the maximum distance of the relative motion of the pair of rolls, V and d are the fiber-drawing speed and the diameter of the fiber, respectively.

Suppose: vₘ=600 r/min, V=600 m/min, L=10 mm, d=0.245 mm, then rot₁=26 turns/m. If V is increased, say V=1000 m/min, then rot₁=15.6 turns/m.

It can be seen from the above theoretical calculation that the effect of twisting of the manner of twisting disclosed in Patents US005897680, US006148131 and US006324872 is dependent of the frequency of the back and forth motion of the pair of rolls vₘ, the maximum distance of the relative motion of the pair of rolls L, the fiber-drawing speed V and the diameter of the fiber d. Under the condition that the maximum distance of the relative motion of the pair of rolls L and the diameter of the fiber d are constant, in order to increase the fiber-drawing speed V and ensure the same effect of twisting, the operation frequency of the twisting system should be increased greatly. Therefore, said manner is unsuitable for high-speed fiber-drawing process.

Additionally, it can be seen from the structure of the twisting system disclosed in Patents US005897680, US006148131 and US006324872 that the realized twist waveform in the length direction of the fiber approximates to the standard waveform of sine function, the typical twist waveform is shown in FIG. 4a.

1.2 The Manner of Continuous Swing of Single Wheel

The manner of continuous swing of single wheel is disclosed in Patents US005298047, US006148131 and US006324872. When there is a certain slope angle θ between the plane in which the main twisting wheel having radius R is located and the fiber-drawing direction, the angular frequency ω of the rotating main twisting wheel can be decomposed into a component in the radial direction of the fiber ω₁=ωsinθ and a component in the fiber-drawing direction ω₂=ωcosθ. The relations between the components of the angular velocity and the motion state of the fiber are the follows:

in the fiber-drawing direction: f₁·V=R·ωcosθ (6)

in the radial direction of the fiber: f₂·R·ωsinθ=υ_{f}·πd (7)

where υ_{f}, d and V are the frequency of the fiber spinning round the axis, the diameter of the fiber, and the fiber-drawing speed, respectively. f₁ is the mechanical efficiency of driving the twisting wheel to spin by the fiber in the fiber-drawing direction, f₂ is the mechanical efficiency of driving the twisting wheel to spin by the fiber in the radial direction of the fiber.

The frequency (in turns/sec) of the fiber spinning round the axis can be obtained from the above two equations:

υ_{f}=(f₁·f₂·V·tgθ)/(πd) (8)

When the fiber-drawing speed is taken into account, the frequency of the fiber spinning round the axis is (in turns per meter):

$$\begin{matrix}{rot}_{θ} = {υ}_{f} / V \\ = ( {f}_{1} \cdot {f}_{2} \cdot tg θ ) / ( π d ) \\ = ( {f}_{0} \cdot tg θ ) / ( π d )\end{matrix} \qquad ( 9 )$$

where f₀ is the mechanical efficiency of the twisting system, which equals the product of f₁ and f₂.

For the sake of convenience in theoretical calculation, in the swing process of the main twisting wheel, it is supposed that the angular velocity of the main twisting wheel ω₀ and the fiber-drawing speed V are constant, then the mean value of the turns per meter of the fiber spinning round the axis in a period T (=1/vₘ, vₘ is the swing frequency of the twisting wheel) is:

$$\begin{matrix}{rot}_{2} = [ {\int }_{0}^{{θ}_{max}} ( {f}_{0} \cdot tg θ ) / ( π d ) \cdot ⅆ θ ] / {θ}_{max} \\ = - ln cos {θ}_{max} \cdot {f}_{0} / ( π d \cdot {θ}_{max} )\end{matrix} \qquad ( 10 )$$

Suppose: f₀=0.5, θₘₐₓ=π/18, d=0.245 mm, then rot₂=58 turns/m.

It can be seen from the above theoretical calculation that the effect of twisting of the manner of twisting disclosed in Patents US005298047, US006148131 and US006324872 is independent of the fiber-drawing speed V and the twisting frequency, and it is suitable for high-speed fiber-drawing process theoretically. In order to increase the effect of twisting, the maximum slope angle of the twisting wheel should be increased. However, when the maximum slope angle of the twisting wheel is increased and greater than 20°, the rotation of the twisting wheel driven by the fiber is rather difficult.

It can be seen from the above theoretical calculation that the realized twist waveform of the twisting system disclosed in Patents US005298047, US006148131 and US006324872 in the length direction of the fiber approximates to the waveform of tangent function, the typical twist waveform is shown in FIG. 4b.

1.3 The Manner of Intermittent Swing of Paired-Roll (which is the Manner of Twisting of the Invention)

Consider the combination effect of three motions formed in a period T by the four physical parameters of the twisting system of the invention:

when the twisting wheels stay in their vertical position, there is not a velocity component in the horizontal direction, and the fiber does not spin;

when the twisting wheels stay in the maximum slope angle position, their contribution in a period T corresponds to the following mean value of the turns per meter for the fiber spinning round the axis:

rot_{θmax}=(t₂/T)·(f₀·tgθₘₐₓ)/(πd) (11)

when the twisting wheels swing, for the sake of convenience in theoretical calculation, suppose that the angular velocity ω₀ of the main twisting wheel and the fiber-drawing speed V are constant, then ω₀=4 θₘₐₓ/(T−t₁−t₂), their contribution in a period T corresponds to the following mean value of the turns per meter for the fiber spinning round the axis:

$$\begin{matrix}{rot}_{θ} = ( 1 - {t}_{1} / T - {t}_{2} / T ) \cdot [ {\int }_{0}^{{θ}_{max}} ( {f}_{0} \cdot tg θ ) / ( π d ) \cdot ⅆ θ ] / {θ}_{max} \\ = ( 1 - {t}_{1} / T - {t}_{2} / T ) \cdot \{ - ln cos {θ}_{max} \cdot {f}_{0} / ( π d {θ}_{max} ) \}\end{matrix} \qquad ( 12 )$$

Thus the contribution of four physical parameters in a period T corresponds to the following mean value of the turns per meter for the fiber spinning round the axis:

$$\begin{matrix}{rot}_{3} = ( {rot}_{θ max} + {rot}_{θ} ) \\ = ( {t}_{2} / T ) \cdot ( {f}_{0} \cdot tg {θ}_{max} ) / ( π d ) + \\ ( 1 - {t}_{1} / T - {t}_{2} / T ) \cdot \{ - ln cos {θ}_{max} \cdot {f}_{0} / ( π d {θ}_{max} ) \}\end{matrix} \qquad ( 13 )$$

Suppose the process parameters of the manner of continuous swing of single wheel are adopted, i.e. f₀=0.5, θₘₐₓ=π/18, d=0.245 mm, then the different effects of twisting can be realized by selecting different proportions of time distribution within a swing period:

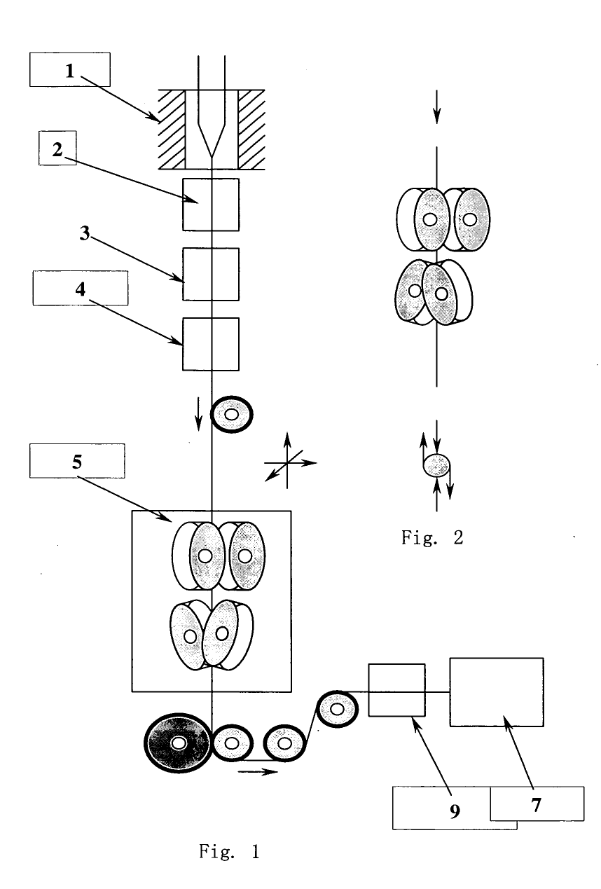

suppose: t₁/T=t₂/T=0, then rot₃=58 turns/m, the effect is the same as that of adopting the manner of continuous swing of single wheel, the corresponding twist waveform is shown in FIG. 4c-1;

suppose: t₁/T=t₂/T=0.25, then rot₃=57.6 turns/m, the effect is the same as that of adopting the manner of continuous swing of single wheel, but the twist waveform of the fiber is different from that of adopting the manner of continuously swing of a single wheel, the corresponding waveform is shown in FIG. 4c-2;

suppose: t₁/T=0, t₂/T=0.5, then rot₃=86.3 turns/m, the effect of twisting is superior to that of adopting the manner of continuous swing of single wheel, the corresponding waveform is shown in FIG. 4c-3.

It can be seen from the above theoretical calculation that the effect of twisting of the twisting system of the invention is independent of the fiber-drawing speed V and the twisting frequency, and it is suitable for high-speed fiber-drawing process theoretically. In order to increase the effect of twisting, the maximum slope angle of the twisting wheel should be increased or the time distribution proportion within the swing period can be adjusted. More turns of twisted fiber can be obtained and more waveforms of twisted fiber can be selected than that case in which the manner of continuous swing of single wheel is adopted.

Furthermore, it can be seen from the above theoretical calculation that the twisting system of the technical solution of the invention can realize different twist waveforms in the length direction of the fiber by adopting different time distribution proportion within a period. As seen in FIG. 4c, there are three typical types of the twist waveform:

a. the twist waveform does not include the components of constant amplitude and constant frequency and the non-twisted component within a period, as seen in FIG. 4c-1;

b. the twist waveform includes the components of constant amplitude and constant frequency and the non-twisted component within a period, as seen in FIG. 4c-2;

c. the twist waveform includes the components of constant amplitude and constant frequency, but does not include the non-twisted component within a period, as seen in FIG. 4c-3.

The characteristics of the fiber manufactured by the manufacturing method of the invention are: the typical mean value of the twist of said fiber is 25˜100 turns/m, the distribution waveforms of the twisted fiber in the length direction thereof are different forms to combine periodically the components of constant amplitude and constant frequency the components of variable amplitudes and variable frequencies. The value of the PMD coefficient of the fiber is not greater than 0.03 ps/km^{1/2}.

Referring to FIG. 1, according to the embodiments of the invention, the single-mode fiber having low PMD is manufactured by the following method: fixing a φ 80 preform prepared by rod-in-tube process to a preform feeding mechanism at the top of a fiber-drawing tower; then sending it into a fiber-drawing heating furnace 1 having a temperature of 2200° C. and performing the fiber-drawing process at 1000 m/min therein; making the drawn fiber to pass through bare fiber geometrical dimension monitor 2, cooling system 3, coating system 4, twisting system 5, fiber-drawing tension wheel, finished optical fiber geometrical dimension monitor system 6 and take-up system 7, successively. Among others, the fiber is forced to spin round its axis under the action of the torque introduced by the twisting system 5. The spin direction of the fiber is changed periodically along with the back and forth swing of the twisting wheel in a plane that is parallel to the fiber, and a special mechanical wave is formed. Such a mechanical wave can propagate along the fiber towards the upstream fiber-drawing direction. Such a mechanical wave can attain the softened region of a preform in the fiber-drawing furnace, it causes a plastic deformation of the glass material in the softened region, and said deformation is set up in the newly drawn fiber. The characteristics are:

a. the introduction of said twisting system does not change the motion path of the drawn fiber, nor deteriorates the possible high-frequency dither which may be generated in the fiber-drawing process;

b. a pair of twisting wheels of said twisting system apply their action on the fiber, the swing direction and the axial slope angle to the fiber of the plane in which the two twisting wheels are located and the axis of the fiber are always in axial symmetrical state, and the two twisting wheels always apply a given compressive stress on the fiber, the magnitude of the compressive stress is 5N, so that a good friction between the fiber and the twisting wheels is ensured;

c. the driving force introduced by the twisting system does not apply to the fiber directly, and the driving force for twisting fiber originates from the friction between the fiber moving in the fiber-drawing direction and the twisting wheels; and the twist of the fiber is realized through the following manner: when there is a slope angle between the plane in which the twisting wheels are located and the fiber-drawing direction, the moving optical fiber brings along the twisting wheels to rotate round the axis of the fiber through friction, the fiber radial component of the angular velocity for the rotation of the twisting wheels applies reaction on the fiber through friction, so that the twist of the fiber is produced;

d. the twisting system has a pair of positioning wheels, and the plane in which said positioning wheels are located and the plane in which the moving twisting wheels are located are always perpendicular each other, the outer surface of the positioning wheels do not apply compressive stress on the optical fiber;

e. a hard metal alloy having high polish precision may be selected as the material of the twisting wheels or the positioning wheels of said twisting system that contact with the fiber directly, the value of the surface roughness thereof is 3 microns;

f. the motion formed by the twisting wheel has three forms: a pair of twisting wheels are stable in their vertical positions simultaneously, the time proportion thereof is denoted as t₁; a pair of axes of twisting wheels are stable in their maximum slope angle positions symmetrically, the time proportion thereof is denoted as t₂; and a pair of axes of twisting wheels swing symmetrically between their vertical positions and maximum slope angle positions, and the time proportion thereof is denoted as t₃; and thus the twist of fiber produced by the twisting system can be controlled through the control of the maximum slope angle swinging by the twisting wheels and the proportion of time distribution among three motion forms, and three groups of process parameters are adopted according to the different time distribution proportions of three forms of motions, as shown in Table 1; and

g. the maximum slope angle swinging by the plane in which the twisting wheels are located is π/18.

Three groups of main process parameters adopted in the embodiments and the tested and calculated results are listed in Table 1. The typical PMD coefficients of the single-mode fibers manufactured by the two disclosed technologies are also cited therein.

TABLE 1
PMD coefficients and main process parameters of fibers
manufactured by three typical manners of twisting
PMD coefficients and main process parameters of the
fibers manufactured by the embodiments

| Main parameters of | Fiber-drawing speed | | | 1000 m/min |
|---|---|---|---|---|
| fiber-drawing process | Fiber-drawing temperature | | | 2200□ |
| | Preform outer diameter | | | φ80 mm |
| | Finished fiber outer diamete | | | 0.245 mm |
| Main process | Swing frequency | | | 60 r/min |
| parameters of twisting | Maximum slope angle of | | | π/18 |
| system | swinging | | | |
| | Mechanical efficiency of | | | 0.5 |
| | twisting | | | |
| Intermittent swing | 1st | PMD coefficient | | 0.030 ps/km^{1/2} |
| of paired-roll (twisting | group of | Calculated mean | | 58 turns/m |
| manner of the | embodiments | turns/m | | |
| invention) | | Time | t₁ | 0 |
| | | distribution | t₂ | 0 |
| | | proportion | t₃ | 100% |
| | 2nd | PMD coefficient | | 0.025 ps/km^{1/2} |
| | group of | Calculated mean | | 57.6 turns/m |
| | embodiments | turns/m | | |
| | | Time | t₁ | 25% |
| | | distribution | t₂ | 25% |
| | | proportion | t₃ | 50% |
| | 3rd | PMD coefficient | | 0.014 ps/km^{1/2} |
| | group of | Calculated mean | | 86.3 turns/m |
| | embodiments | turns/m | | |
| | | Time | t₁ | 0 |
| | | distribution | t₂ | 50% |
| | | proportion | t₃ | 50% |

Typical PMD coefficients of single-mode fibers manufactured
by disclosed prior art technologies

| | | |
|---|---|---|
| Horizontal twist | Typical PMD coefficient | 0.033˜0.05 ps/km^{1/2} |
| with paired-roll | Published relevant patents | |
| | Published relevant patents | U.S. Pat. No. 5,897,680, |
| | | U.S. Pat. No. 6,148,131 |
| Continuous | Typical PMD coefficient | <0.5 ps/km^{1/2} |
| swing of single | Published relevant patents | U.S. Pat. No. 5,298,047, |
| wheel | | U.S. Pat No. 5,418,881 |

1. A method for manufacturing low PMD single-mode fiber comprising the steps of:
fixing a preform to a preform feeding mechanism at the top of a fiber-drawing tower;
sending said preform into a fiber-drawing heating furnace and performing the fiber-drawing process therein;
making the drawn fiber to pass through bare fiber geometrical dimension monitor, coating system, twisting system, fiber-drawing tension wheel, finished optical fiber geometrical dimension monitor system, and take-up system successively, wherein
said fiber is forced to spin round its axis under the action of the torque introduced by said twisting system; the spin direction of said fiber is changed periodically along with the back and forth swing of twisting wheel in a plane that is parallel to said fiber, and a special mechanical wave is formed; said mechanical wave propagates along the fiber towards the upstream fiber-drawing direction and attains the softened region of a preform in said fiber-drawing furnace; said mechanical wave causes a plastic deformation of the glass material in said softened region, and said deformation is set up in the newly drawn fiber;
a pair of twisting wheels of said twisting system apply their action on said fiber, the swing direction and the axial slope angle to the fiber of the plane in which the two twisting wheels are located and the axis of said fiber are always in axial symmetrical state, and said two twisting wheels always apply a given compressive stress on said fiber; and
the driving force introduced by said twisting system indirectly exerts to the fiber, and the driving force for twisting fiber originates from the friction between said fiber moving in the fiber-drawing direction and said twisting wheels.

2. The method of manufacturing low PMD single-mode fiber according to claim 1, wherein the magnitude of said compressive stress is typically 0.5˜5N, so that a good friction between said fiber and said twisting wheels is ensured.

3. The method of manufacturing low PMD single-mode fiber according to claim 1, wherein the twist of the fiber is realized through the following manner: when there is a slope angle between the plane in which said twisting wheels are located and the fiber-drawing direction, the moving fiber brings along said twisting wheels to rotate round their axes respectively through friction, the fiber radial component of the angular velocity for the rotation of said twisting wheels applies reaction on said fiber through friction, and the twist of the fiber is produced.

4. The method of manufacturing low PMD single-mode fiber according to claim 1, wherein the typical mean value of the turns per meter of said twisted fiber ranges from 25 to 100 turns/m, and the typical PMD coefficient of said fiber is not greater than 0.03 ps/km^{1/2}.

5. The method of manufacturing low PMD single-mode fiber according to claim 1, wherein the distribution waveform of the twisted fiber in the length direction thereof is realized in different forms to combine periodically the components of constant amplitude and constant frequency with the components of variable amplitudes and variable frequencies, the typical twist waveform includes the following three forms:
a. said twist waveform does not include constant amplitude components and constant frequency components and non-twisted component in a period;
b. said twist waveform includes constant amplitude components and constant frequency components and non-twisted component in a period; and
c. said twist wave form includes constant amplitude components and constant frequency components, but does not include non-twisted component in a period.

6. The method of manufacturing low PMD single-mode fiber according to claim 1, wherein said twisting system has a pair of positioning wheels, the plane in which said positioning wheels are located and the plane in which the moving twisting wheels are located are always perpendicular each other, the outer surface of said positioning wheels do not apply compressive stress on the fiber.

7. The method of manufacturing low PMD single-mode fiber according to claim 3, wherein a hard alloy having high polish precision may be selected as the material of said twisting wheels or said positioning wheels of said twisting system that contact with said fiber directly, the value of the surface roughness thereof is 3 microns, ceramic material, hard rubber material or plastic material may also be selected.

8. The method of manufacturing low PMD single-mode fiber according to claim 1, wherein the motion formed by said twisting wheel has three forms: a pair of twisting wheels are stable in their vertical positions simultaneously; a pair of axes of twisting wheels are stable in their maximum slope angle positions symmetrically; and a pair of axes of said twisting wheels swing symmetrically between their vertical positions and maximum slope angle positions.

9. The method of manufacturing low PMD single-mode fiber according to claim 8, wherein the twist is produced by said twisting system, and it can be controlled through the control of the swing angle of the twisting wheels and the proportion of time distribution among three motion forms.

10. The method of manufacturing low PMD single-mode fiber according to claim 9, wherein the typical value of the maximum slope angle swinging by the plane in which said twisting wheels are located ranges from 5 to 20 degrees.

11. The method of manufacturing low PMD single-mode fiber according to claim 1, wherein said fiber preform may be a solid preform or a fiber preform prepared by rod-in-tube process, the typical value of the outer diameter of said preform ranges from 40 mm to 150 mm, the typical fiber-drawing speed of said fiber-drawing tower ranges from 400 m/min to 1500 m/min, said fiber-drawing heating furnace includes mainly graphite resistance furnace and graphite induction furnace, the typical value of fiber-drawing temperature ranges from 1730° C. to 2300° C.

12. The method of manufacturing low PMD single-mode fiber according to claim 1, wherein the typical mean value of the twist of said fiber is 25˜100 turns/m; the distribution waveform of the twist of the fiber in the length direction are different forms to combine periodically constant amplitude components and constant frequency components with variable amplitude components and variable frequency components; and the typical value of the coefficient of PMD of the optical fiber is not greater than 0.03 ps/km^{1/2}.
